(19) United States
(12) Patent Application Publication
(10) Pub. No.: US 2022/0061202 A1
(43) Pub. Date: Mar. 3, 2022

(54) Automated Agricultural Implement Orientation Adjustment System And Related Devices And Methods

(71) Applicant: Ag Leader Technology, Ames, IA (US)

(72) Inventors: Joe Holoubek, Ames, IA (US); David Wilson, Prairie City, IA (US)

(21) Appl. No.: 17/461,839

(22) Filed: Aug. 30, 2021

Related U.S. Application Data
(60) Provisional application No. 63/071,819, filed on Aug. 28, 2020.

(51) Int. Cl. A01B 63/14; A01B 79/02

(52) U.S. Cl. CPC A01B 63/14; A01C 7/08; A01B 79/02

(57) ABSTRACT

The disclosed apparatus, systems, and methods relate to an automated hitch and various alternative devices to adjust the orientation of an agricultural implement and component parts thereof, including but not limited to a planter toolbar and/or planter row units relative to the soil surface to ensure the implement/components parts thereof maintain a position parallel to the soil surface.

### CROSS REFERENCE TO RELATED APPLICATION(S)

This application claims the benefit under 35 U.S.C. § 119(e) to U.S. Provisional Application 63/071,819, filed Aug. 28, 2021, and entitled “Apparatus, Systems and Methods for an Automated System to Adjust Planter Toolbar Angle,” which is hereby incorporated herein by reference in its entirety for all purposes.

### TECHNICAL FIELD

The disclosure relates to agricultural implements, vehicle connections, hitches, and adjustment mechanisms therefor. In particular, the disclosure relates to devices, systems, and methods for automated adjustments to the planter toolbar angle and/or row unit angle relative to the soil surface.

### BACKGROUND

Various existing implements and their corresponding hitches are fixed and do not compensate for changes in the terrain, which can negatively impact planting and other operations. Thus, there is a need in the art for an implement hitch, individual row unit and/or section adjustment to ensure proper operation of the implement.

### BRIEF SUMMARY

Described herein are various embodiments relating to devices, systems, and methods for an automated implement orientation adjustment system. To achieve proper planting depth and high seed trench quality a planting row unit must travel at the proper angle in relation to the soil surface. In certain implementations, this disclosure relates to various devices, systems, and methods for maintaining a planter and/or planter row units in an orientation parallel or nearly parallel to the soil surface during planting, such as at the location the seed trench is created and/or where seeds are deposited. This has implications for improving planting by ensuring the planting implement and/or its component parts maintain proper positioning relative to the soil surface during planting.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

According to one embodiment, the system for automated hitch height adjustments includes a GPS, a controller, and a hitch wherein the controller determines a soil angle, and the hitch is urged either up or down vertically so as to place a planter and row units in a substantially parallel orientation relative to the soil.

In another embodiment, the system includes telescoping or otherwise adjustable parallel linkage arms and is constructed and arranged to adjust the length of the parallel linkage arms in order to effectuate change in the angle of the row unit relative to the soil surface.

In another embodiment, the system includes a hinged plate and actuator disposed on a toolbar. In this example, the hinged plate can be actuated between various positions effectuating change in the angle of the row unit relative to the soil surface.

In Example 1, a system for controlling planter hitch orientation comprising a tilt sensor, an operations unit in communication with the tilt sensor, comprising a controller, a memory in communication with the controller, and a communications component in communication with the controller, and at least one actuator in communication with the operations unit, wherein signal from the tilt sensor detect a pitch of a soil surface, and wherein the operations unit sends signals to the at least one actuator to control an angle of a planter to match or nearly match the pitch of the soil surface.

In Example 2, the system of Example 1, wherein the at least one actuator is configured to retract and extend a parallel linkage arm connected to a row unit.

In Example 3, the system of Example 1, at least one hinged plate connected to the at least one actuator wherein actuation of the actuator causes extension and retraction of the at least one hinged plate.

In Example 4, the system of Example 1, further comprising a height sensor configured to be attached to the planter and for measurement of distance between a toolbar and the soil surface.

In Example 5, the system of Example 4, wherein the height sensor is one or more of a LiDAR sensor or a sonic sensor.

In Example 6, the system of Example 1, wherein actuation of the actuator is on-the-go.

In Example 7, the system of Example 1, further comprising a GPS receiver in communication with the operations unit, the GPS receiver configured to log location and soil characteristics.

In Example 8, a system for controlling planter pitch comprising at least one sensor, a controller, and an automated hitch, wherein the at least one sensor records a soil surface angle, and wherein the controller is configured to adjust the automated hitch to align a row unit angle to be substantially equivalent to the soil surface angle.

In Example 9, the system of Example 8, wherein the at least one sensor comprises a GPS, a tilt sensor or a height sensor.

In Example 10, the system of Example 9, wherein when the soil surface angle is higher than the row unit angle, the controller causes the automated hitch to be urged upward to increase row unit angle until the soil surface angle and the row unit angle are substantially equivalent.

In Example 11, the system of Example 10, wherein when the soil surface angle is lower than the row unit angle, the controller causes the automated hitch to be urged downward to decrease the row unit angle until the soil surface angle and the row unit angle are substantially equivalent.

In Example 12, the system of Example 8, wherein the soil surface angle is logged by the system and stored in a memory.

In Example 13, the system of Example 8, further comprising a plurality of tilting wheels disposed across a width of the planter and configured to detect the soil surface angle at various points across the width.

In Example 14, the system of Example 8, wherein the system is further configured to dynamically adjust the row unit angle of one or more row units of the planter via one or more of a telescoping linkage or hinged plate.

In Example 15, a method for controlling planter orientation, comprising recording a soil surface angle, determining a row unit angle, and actuating an actuator such that the soil surface angle and the row unit angle are parallel or nearly parallel.

In Example 16, the method of Example 16, wherein the actuator is configured to raise or lower a hitch.

In Example 17, the method of Example 16, wherein the actuator is configured to extend or retract a telescoping arm of a row unit linkage.

In Example 18, the method of Example 16, wherein the soil surface angle is detected from one or more stored maps.

In Example 19, the method of Example 16, wherein the row unit angle is determined by one or more of a GPS, a tilt sensor or a height sensor.

In Example 20, the method of Example 16, wherein actuation of the actuator is on-the-go in real time or near-real time.

Other embodiments of these Examples include corresponding computer systems, apparatus, and computer programs recorded on one or more computer storage devices, each configured to perform the actions of the methods. Implementations of the described techniques may include hardware, a method or process, or computer software on a computer-accessible medium, or computer programs recorded on one or more computer storage devices, each configured to perform the actions of the methods.

While multiple embodiments are disclosed, still other embodiments of the disclosure will become apparent to those skilled in the art from the following detailed description, which shows and describes illustrative embodiments of the disclosed apparatus, systems, and methods. As will be realized, the disclosed apparatus, systems and methods are capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1A is a side view of an exemplary embodiment of the system, according to one implementation.

FIG. 1B is a perspective view of an adjustable hitch, according to one implementation.

FIG. 2 is a perspective view of a planter, according to one implementation.

FIG. 3 is a side view of a row unit, according to one implementation.

FIG. 4 is a schematic depiction of the system, according to one implementation.

FIGS. 5A-C are side views of a prior known planter traversing a hill, according to one implementation.

FIGS. 6A-C show side view of a prior known planter at various angles/heights, according to one implementation.

FIG. 7 is a perspective view of a field after passage of a planter in an angled down position, according to one implementation.

FIG. 8 is a close-up view of the field of FIG. 7, according to one implementation.

FIG. 9A is a side view of tractor and planter implementing the system, according to one implementation.

FIG. 9B is a schematic diagram showing orientations of a row unit and the soil surface, according to one implementation.

FIG. 9C is a flow diagram of the system, according to one implementation.

FIG. 10A is a flow diagram of the system, according to one implementation.

FIG. 10B is a side view schematic showing an implementation of the system configured to determine the relevant angles on the basis of readings made exclusively from the tractor, according to one implementation.

FIGS. 11A-C show side views of a tractor and planter implementing the system and traversing a hill and valley, according to one implementation.

FIG. 12 is a flow diagram of the system, according to one implementation.

FIG. 13 is a flow diagram of the system, according to one implementation.

FIGS. 14A-C show side views of a row unit with a telescoping parallel row unit arm at various positions, according to one implementation.

FIG. 15A is a side view of a telescoping parallel arm, according to one implementation.

FIG. 15B is a close-up view of the telescoping arm of FIG. 15A, according to one implementation.

FIG. 15C is a flow chart showing the use of the telescoping arm, according to one implementation.

FIG. 16 is a side view of an articulated telescoping arm, according to one implementation.

FIGS. 17A-C show side views of a row unit with a hinged plate at various positions, according to one implementation.

FIG. 18 is a side view of a hinged plate, according to one implementation.

FIG. 19A is a side view of a planter with tilting wheels, according to one implementation.

FIG. 19B is a side view of the planter with tilting wheels of FIG. 19A on an incline, according to one implementation.

FIG. 19C is a top view of the planter with tilting wheels of FIG. 19A spaced across the toolbar, according to one implementation.

### DETAILED DESCRIPTION

Discussed herein are various devices, systems, and methods relating to a planter orientation control system, including in some implementations an automated hitch. The various implementations described herein are configured to control the angle/pitch of a planter, hitch, and/or other component parts thereof with respect to the soil surface to improve planting conditions and thereby maximize/improve yields.

In various implementations, the control system continuously or periodically monitors the slope/grade/incline of the terrain as a tractor traverses the terrain during planting or other agricultural operations. In certain implementations, the control system adjusts the angle/pitch of a hitch, planter, and/or one or more row units such that at the seeding point the row units are parallel or nearly parallel with the soil surface.

It would be understood that various implementations of the control system may improve the quality of planting because the system ensures the planter and/or its row units remain parallel or near parallel to the soil surface throughout planting, particularly as the planter traverses uneven or sloped terrain ensuring that the various components of the row units can function correctly.

Certain of the disclosed implementations can be used in conjunction with any of the devices, systems or methods taught or otherwise disclosed in U.S. Pat. No. 10,684,305 issued Jun. 16, 2020, entitled “Apparatus, Systems and Methods for Cross Track Error Calculation From Active Sensors,” U.S. patent application Ser. No. 16/121,065, filed Sep. 4, 2018, entitled “Planter Down Pressure and Uplift Devices, Systems, and Associated Methods,” U.S. Pat. No. 10,743,460, issued Aug. 18, 2020, entitled “Controlled Air Pulse Metering apparatus for an Agricultural Planter and Related Systems and Methods,” U.S. patent application Ser. No. 16/272,590, filed Feb. 11, 2019, entitled “Seed Spacing Device for an Agricultural Planter and Related Systems and Methods,” U.S. patent application Ser. No. 16/142,522, filed Sep. 26, 2018, entitled “Planter Downforce and Uplift Monitoring and Control Feedback Devices, Systems and Associated Methods,” U.S. Pat. No. 10,813,281, issued Oct. 27, 2020, entitled “Apparatus, Systems, and Methods for Applying Fluid,” U.S. patent application Ser. No. 16/371,815, filed Apr. 1, 2019, entitled “Devices, Systems, and Methods for Seed Trench Protection,” U.S. patent application Ser. No. 16/523,343, filed Jul. 26, 2019, entitled “Closing Wheel Downforce Adjustment Devices, Systems, and Methods,” U.S. patent application Ser. No. 16/670,692, filed Oct. 31, 2019, entitled “Soil Sensing Control Devices, Systems, and Associated Methods,” U.S. patent application Ser. No. 16/684,877, filed Nov. 11, 2019, entitled “On-The-Go Organic Matter Sensor and Associated Systems and Methods,” U.S. patent application Ser. No. 16/752,989, filed Jan. 27, 2020, entitled “Dual Seed Meter and Related Systems and Methods,” U.S. patent application Ser. No. 16/891,812, filed Jun. 3, 2020, entitled “Apparatus, Systems and Methods for Row Cleaner Depth Adjustment On-The-Go,” U.S. patent application Ser. No. 16/918,300, filed Jul. 1, 2020, entitled “Apparatus, Systems, and Methods for Eliminating Cross-Track Error,” U.S. patent application Ser. No. 16/921,828, filed Jul. 6, 2020, entitled “Apparatus, Systems and Methods for Automatic Steering Guidance and Visualization of Guidance Paths,” U.S. patent application Ser. No. 16/939,785, filed Jul. 27, 2020, entitled “Apparatus, Systems and Methods for Automated Navigation of Agricultural Equipment,” U.S. patent application Ser. No. 16/997,361, filed Aug. 19, 2020, entitled “Apparatus, Systems and Methods for Steerable Toolbars,” U.S. patent application Ser. No. 16/997,040, filed Aug. 19, 2020, entitled “Adjustable Seed Meter and Related Systems and Methods,” U.S. patent application Ser. No. 17/011,737, filed Sep. 3, 2020, entitled “Planter Row Unit and Associated Systems and Methods,” U.S. patent application Ser. No. 17/060,844, filed Oct. 1, 2020, entitled “Agricultural Vacuum and Electrical Generator Devices, Systems, and Methods,” U.S. patent application Ser. No. 17/105,437, filed Nov. 25, 2020, entitled “Devices, Systems and Methods For Seed Trench Monitoring and Closing,” U.S. patent application Ser. No. 17/127,812, filed Dec. 18, 2020, entitled “Seed Meter Controller and Associated Devices, Systems and Methods,” U.S. patent application Ser. No. 17/132,152, filed Dec. 23, 2020, entitled “Use of Aerial Imagery For Vehicle Path Guidance and Associated Devices, Systems, and Methods,” U.S. patent application Ser. No. 17/164,213, filed Feb. 1, 2021, entitled “Row Unit Arm Sensor and Associated Systems and Methods,” U.S. patent application Ser. No. 17/170,752, filed Feb. 8, 2021, entitled “Planter Obstruction Monitoring and Associated Devices and Methods,” U.S. patent application Ser. No. 17/323,649, filed May 18, 2021, entitled “Assisted Steering Apparatus and Associated Systems and Methods,” U.S. patent application Ser. No. 17/369,876, filed Jul. 7, 2021, entitled “Apparatus, Systems, and Methods for Grain Cart-Grain Truck Alignment and Control Using GNSS and/or Distance Sensors,” U.S. patent application Ser. No. 17/381,900, filed Jul. 21, 2021, entitled “Visual Boundary Segmentations and Obstacle Mapping for Agricultural Vehicles,” U.S. Patent Application 63/113,566, filed Nov. 13, 2020, entitled “Apparatus, Systems and Methods for High Speed Row Units,” U.S. Patent Application 63/127,598, filed Dec. 18, 2020, entitled “Devices, Systems, and Method For Seed Delivery Control,” U.S. Patent Application 63/176,408, filed Apr. 19, 2021, entitled “Automatic Steering Systems and Methods,” and U.S. Patent Application 63/186,995, filed May 11, 2021, entitled “Calibration Adjustment for Automatic Steering Systems.”

In certain implementations, the system 10 may be used in conjunction with various agricultural mapping and navigation systems, such as those taught in the incorporated references. As would be appreciated various of these mapping and/or navigation systems may include slope, gradient, and/or other data related to the soil surface that may be used by the system 10.

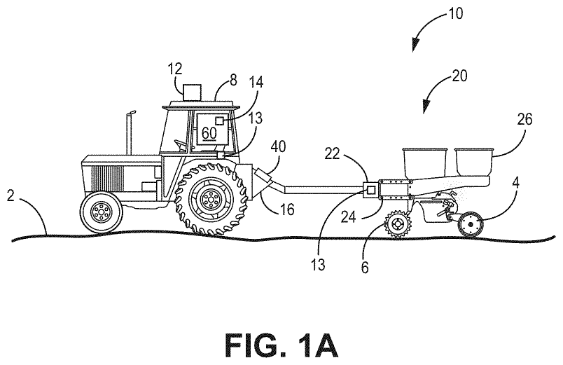

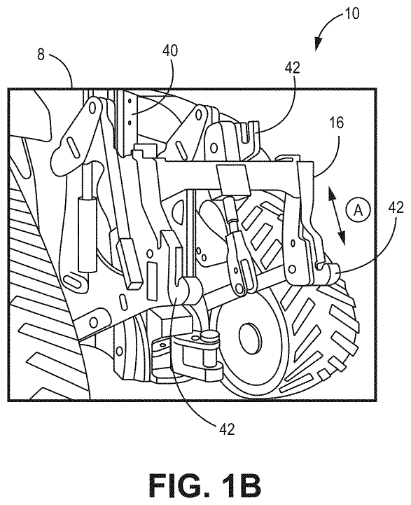

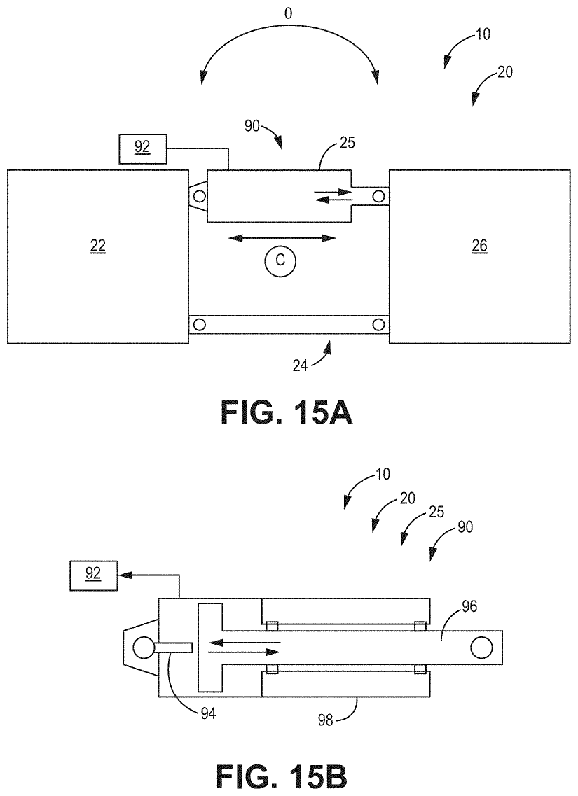

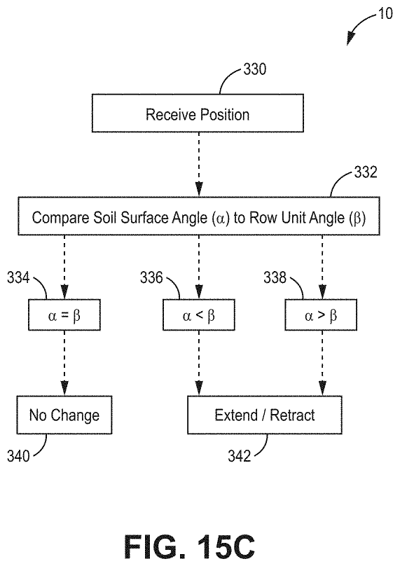

Turning to the drawings in greater detail, FIG. 1A depicts the control system 10 and planter (also referred to herein as a “planting implement” or “implement”) 20, according to an exemplary implementation. In certain implementations, the control system 10 is disposed on and implemented in conjunction with a tractor 8, or other agricultural vehicle 8, a planting implement 20 or planter 20, or other agricultural implement, as would be understood. In various implementations of the control system 10, one or more tilt sensors 13 are provided that are configured to detect a pitch of a soil surface and are in operational communication with one or more actuators 40 (also shown at 90 in FIGS. 15A-B and 16), and to control an angle of the planter 20 and/or its row units 26 to match or nearly match the pitch of the soil surface 2, as will be appreciated from the present disclosure. Exemplary tilt sensors 13 may include inertial measurement units (“IMUs”), gyroscopes, and accelerometers, or other known devices configured to detect one or more of yaw, pitch and/or roll for output via an electronic communication to an operations unit 60 or processor 14 for use as described herein. Further features and implementations are of course possible, and various hardware and software components can be provided to effectuate the processes described herein.

As shown in FIG. 1B, in various implementations of the system 10, the actuator 40 is in operational communication with the hitch 16 so as to urge the mounting points 42 up and/or down (shown at reference arrow A), as would be readily appreciated by those skilled in the field. As would be understood, many planting implements 20 are connected to tractors 8 or other towing vehicles 8 via a 3-point hitch 16. Certain of these known hitches 16 are controlled from inside the cab of the tractor 8, that is the hitch 16 height can be raised or lowered via manual action by an operator. Certain known hitches 16 are typically raised for transport, such as road transport, and lowered during planting operations. These known hitches 16 and operations systems thereof are controlled manually by a user and do not account for movement on-the-go.

In various of the disclosed implementations of the system 10, the movement of the hitch 16 is performed by the system 10 in real time or near-real time to alter pitch, as described herein. It is understood that as discussed herein, the angle of the row unit relative to a fixed horizon or other established reference point is used to adjust the pitch of the planter relative to the soil surface, as would be appreciated.

Returning to FIG. 1A, many planting implements 20 are connected to tractors 8 or other towing vehicles 8 via a hitch 16 with or without a drawbar 18. In certain implementations, the drawbar 18 attaches an implement 20 to the tractor 8, for example by connecting a planter toolbar 22 to the hitch 16. In various implementations, the toolbar 22 is an integral part of the planter 20. In various implementations, the toolbar 22 is a square tube, such as a 7″ by 7″ square tube, although other shapes and sizes are possible. Various alternative configurations of the planting implement 20 are of course possible.

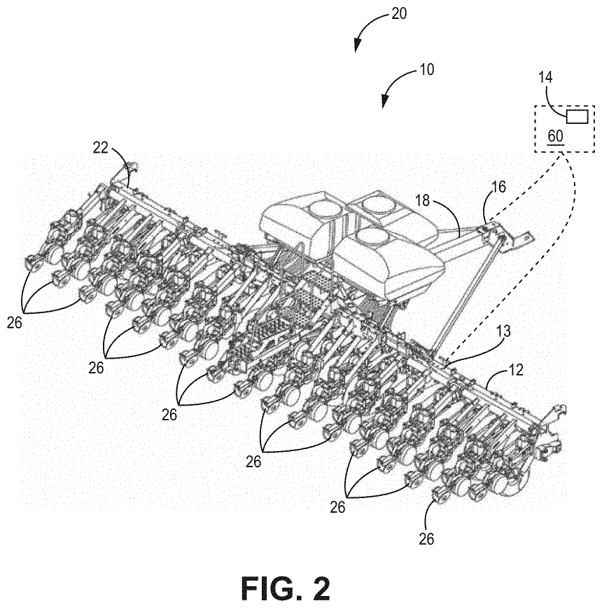

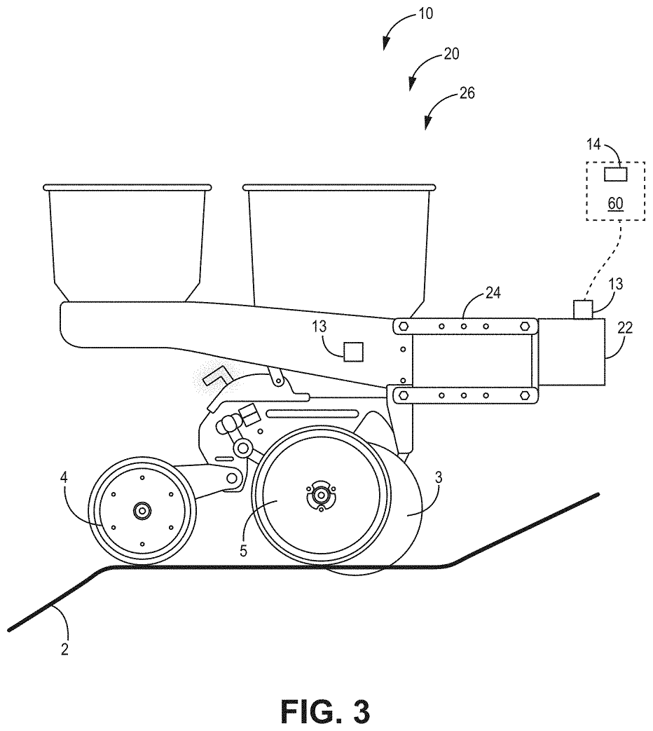

As would be understood, a planter 20 can include a plurality of row units 26, as shown in overview in FIG. 2. In certain implementations, these planter row units 26 are disposed on the toolbar 22 via parallel arms 24, as has been previously described and would be understood by those of skill in the art. A side view of such a row unit 26 is shown for example in FIG. 3. Various alternative connection types/linkages 24 between the row units 26 and the toolbar 22 are of course possible and would be understood by those of skill in the art. The various implementations of the system 10 disclosed herein can supplement previously described downforce systems by providing additional correction of the row unit 26 pitch relative to the terrain via the operation of the hitch 16, as will be explained herein.

Further, as shown in FIG. 3, planter row units 26 like those adjusted by the system 10 may include a variety of components in various configurations as would also be appreciated. For example, a planter row unit 26 may include one or more opening discs 3 configured to cut into the soil and create a seed trench. Further, the row units 26 may include one or more gauge wheels 5 configured to set and control the depth of the seed trench. In further implementations, the row unit 26 may include one or more closing discs 4 configured to urge soil back into the seed trench after the seed is deposited. Various additional components such as but not limited to a firmer and/or row cleaner (shown for example in FIG. 1A at 6) may also be included, as would be understood, and as has been previously described in the incorporated references. Optimal operation of these components is achieved when the row unit 26 is at the same pitch as the soil surface 2.

Continuing with the examples of FIGS. 1A-3, in various implementations, the system 10 includes a GPS/GNSS receiver 12 disposed on a tractor 8, planter 20, row unit 26, or other agricultural vehicle 8 that is configured to locate the tractor 8, planter 20, row unit 26, or other agricultural vehicle 8. It is understood that the term GNSS refers to Global Navigation Satellite System. GNSS is the standard generic term for satellite navigation systems that provide autonomous geo-spatial positioning with global coverage. Certain non-limiting examples include GPS, GLONASS, Galileo, Beidou and other global navigation satellite systems. It is understood that, for example, the terms GNSS and GPS (global positioning system) are used interchangeably in the disclosure.

Further, in certain implementations, an operations unit 60 having a controller 14 is in communication with the GPS receiver 12 and, optionally, the hitch 16. In various implementations, the operations unit 60 may also be in communication with one or more actuators 40, 90 disposed on or in communication with the hitch 16, toolbar 22, planter 20, row units 26, and/or linkages 24.

It is appreciated that the operations unit 60 can comprise various software and hardware components necessary for the effectuation of the various process steps and actions described herein, such as by issuing commands to the various components described herein in real-time.

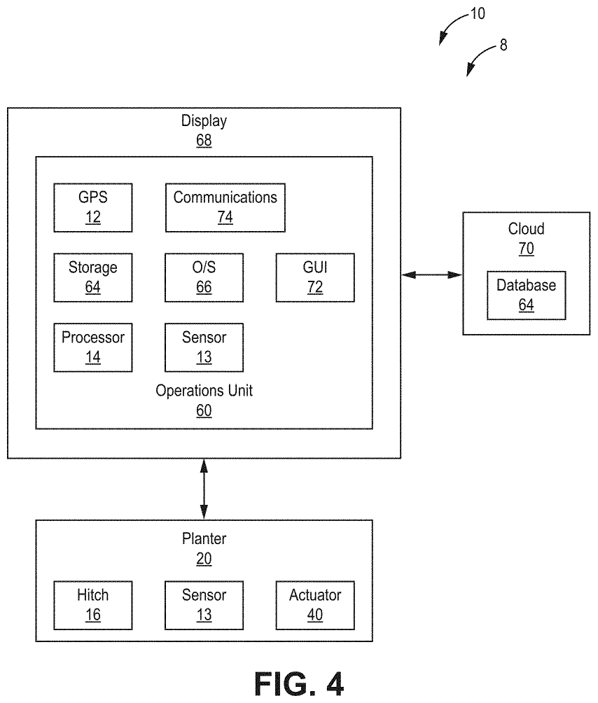

A schematic depiction of one implementation of the system 10 is shown in FIG. 4. In such implementations, the system 10 includes an operations unit 60 configured to execute and perform various steps and functions of the system 10. In certain implementations, the operations unit 60 comprises the various processing and computing components necessary for the operation of the system 10, including receiving, recording, and processing the various received signals, generating the requisite calculations and commanding the various hardware, software, and firmware components necessary to effectuate the various processes described herein. That is, in certain implementations, the operations unit 60 comprises a processor/controller 14 that is in communication with memory 64 and an operating system (“O/S”) 66 or software and sufficient media to effectuate the described processes, and can be used with an operating system 66, memory/data storage 64 and the like, as would be readily appreciated by those of skill in the art. It is appreciated that in certain implementations, the data storage 64 can be local or cloud 70 based, or some combination thereof.

In various implementations, the system's 10 operations unit 60 can comprise a circuit board, a microprocessor, a computer, or any other known type of controller 14, processor 14, or central processing unit (CPU) 14 that can be configured to assist with the operation of the system 10, such as via the various devices disclosed or contemplated herein. In further embodiments, a plurality of CPUs 14 can be provided and operationally integrated with one another and the various components. Further, it is understood that one or more of the operations units 60 and/or its processors 14 can be configured via programming or software to control and coordinate the recordings from and/or operation of the various sensor components, such as the tilt sensors 13, as would be readily appreciated.

Continuing with the implementation of FIG. 4, the tilt sensors 13 are in operational communication via a wired or wireless connection with an operations system 60. In some implementations, the system 10 provides an operations system 60 optionally comprised in a display 68, such as the InCommand® display from Ag Leader®. In alternative implementations, the operations system 60 may optionally be disposed on a cloud-based system 70, and/or comprise both local/display 68 based components as well as cloud 70 based components, as would be understood.

The display 68 and/or remote cloud system 70 may include a graphical user interface (“GUI”) 72 and optionally a graphics processing unit (“GPU”), in various implementations. In these and other implementations, the GUI 72 and/or GPU allows for the display of information to a user and optionally for a user to interact with the displayed information, as would be readily appreciated. It would be understood that various input methods are possible for user interaction including but not limited to a touch screen, various buttons, a keyboard, or the like.

Further implementations of the operations system 60 includes a communications component 74. The communications component 74 may be configured for sending and/or receiving communications to and from one or more of the vehicles 8, the tilt sensors 13, the cloud system 70, actuators 40, 90 or any other system 10 components, as would be appreciated.

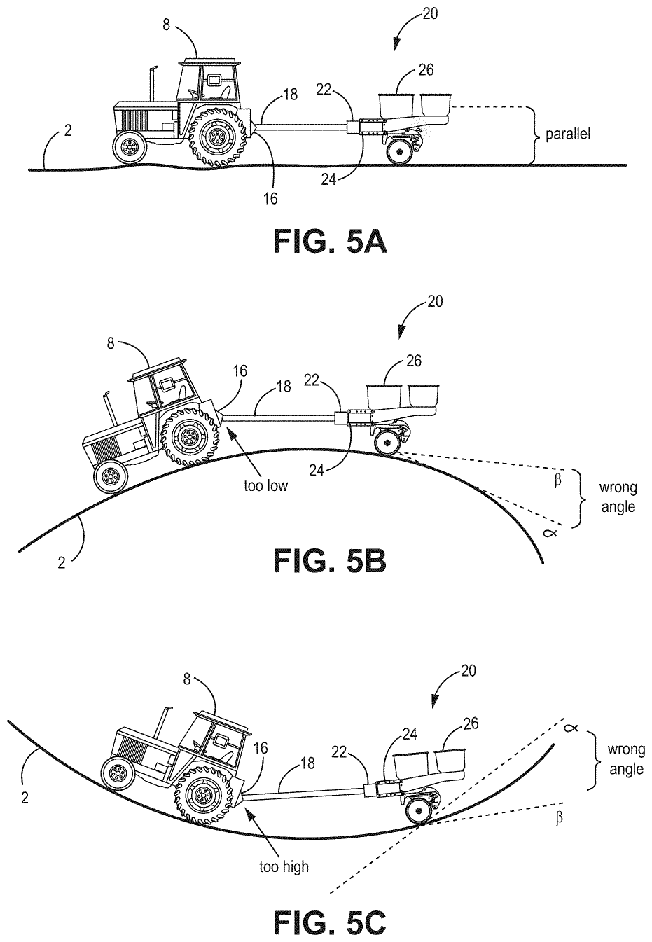

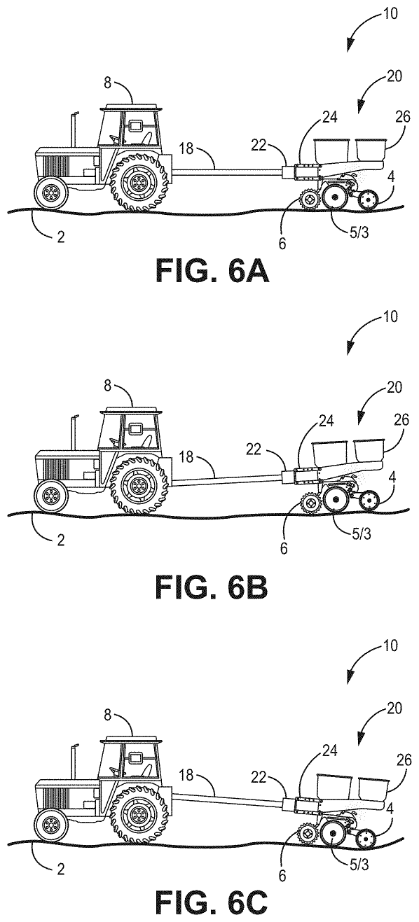

Turning now to FIGS. 5A-6C, as previously described, and as would be understood, various existing hitches 16 can be raised or lowered to accommodate different soil surface 2 angles before planting begins, or for transitioning between a raised transport position and a lowered planting position. However, once in use, these prior known hitches are fixed in position and are adjusted manually. These types of manual adjustments are typically inaccurate and time consuming and as such with prior known hitches a single hitch position is typically used to plant the entire field.

FIGS. 5A-5C show various situations that a planter 20 and fixed hitch 16 may encounter when traversing various terrain. Shown in FIG. 5A, the hitch position at the start of planting is orientated such that the planter 20 and/or its row units 26 are parallel to the soil surface 2. However, when the planter 20 and fixed hitch 16, without the system 10, is traversing a peak or a valley the row units 26 will no longer be parallel to the soil surface 2. For example, as shown in FIG. 5B, on a peak, the hitch 16 position is too low and the planter 20, and therefore the row units 26, are pitched forward, for example digging further into the soil 2 than desired. In another example, shown in FIG. 5C, in a valley, the hitch 16 position is too high and the planter 20, and therefore the row units 26, are pitched backward, lifting off the soil surface 2. The various consequences of improper orientation of the planter 20, other agricultural implement, and/or the row units 26 would be recognized by those of skill in the art.

FIGS. 6A-6C show further disadvantages of improper hitch 16 and planter 20 positioning. Most planter row units 26 and the various components thereof including the opening discs 3, row cleaners 6, and closing discs 4 are designed to run parallel or nearly parallel to the soil surface 2, as would be appreciated. For example, when the planter 20 and/or row unit(s) 26 are not parallel to the soil surface 2 the quality of the seed trenches created by the opening discs 3 is worsened. Shown in FIG. 6B, when the hitch position is low the opening discs 3 will create a trench that is too narrow and too deep. In this example seeds will not be properly dispersed in the trench and may be planted too deep resulting in late emergence—a cause of lost yield. Additionally, in certain implementations, if the planter 20 is pitched forward due to the hitch 16 height being too low row cleaners 6 may be positioned too low and create undesirable gouges in the soil ahead of the seed trench.

In a further example, shown in FIG. 6C, when the hitch 16 position is too high, the opening discs 3 may create a “W” shaped seed trench or shallow seed trench, due to not being able to reach the desired depth in the soil 2. In this example, seeds will not be properly placed in the seed trench. The uneven placement of seeds may then result in uneven emergence of crops, uneven rows, and other consequences known to negatively affect overall crop yield.

Improper hitch placement can also impact the functionality of the row cleaners 6 and closing discs 4. For example, when the hitch position is too low and the planter 20/row units 26 are angled forward or towards the soil surface 2, the row cleaners 6 will be pitched forward and create a ditch deeper than desired. Further, the closing discs 3 may be pitched upward and will not apply adequate closing force to close the trench.

In another example, when the hitch position is too high and the planter 20 is angled backwards or away from the soil surface 2, row cleaners 6 may be pitched upward and not clear enough of the debris in front of the row unit 26 and seed trench. Additionally, the closing discs 4 will be pitched back and apply too much closing force compacting soil and negatively effecting seed emergence.

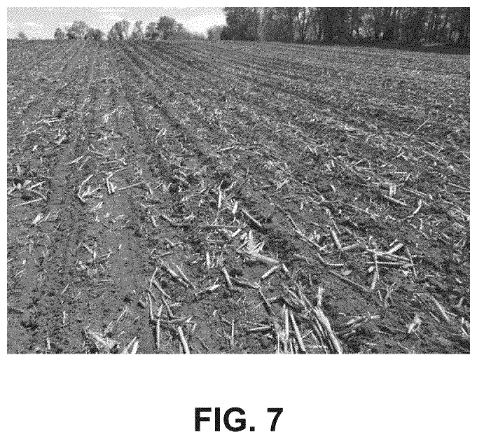

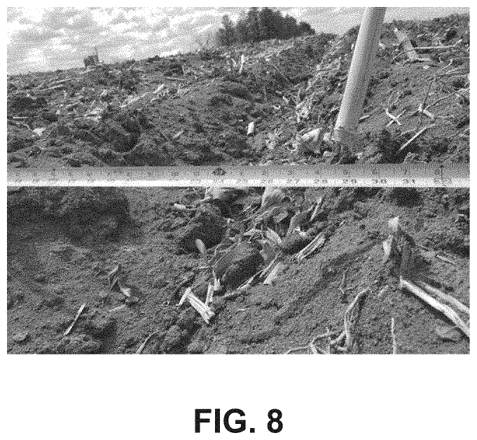

FIGS. 7-8 further exemplify disadvantages of improper hitch positioning. FIG. 7 shows trenches on an incline that were created by a planter 20 attached with a too low hitch position. FIG. 8 shows the same trenches in greater detail. As exemplified in both FIGS. 7-8, the trenches are too deep because the row cleaner 6 was pitched into the soil surface 2 due to the row units 26 not being parallel to the soil because of improper planter 20 or row unit 26 orientation/hitch 16 position.

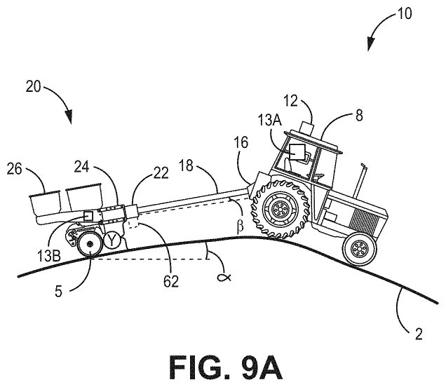

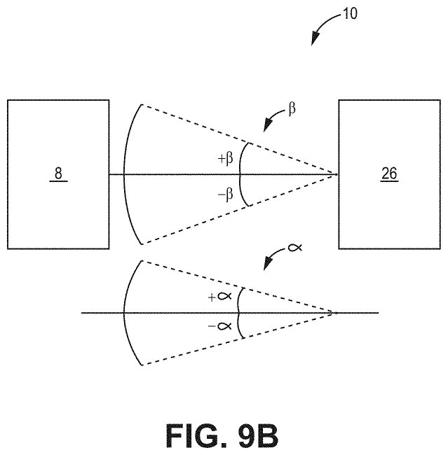

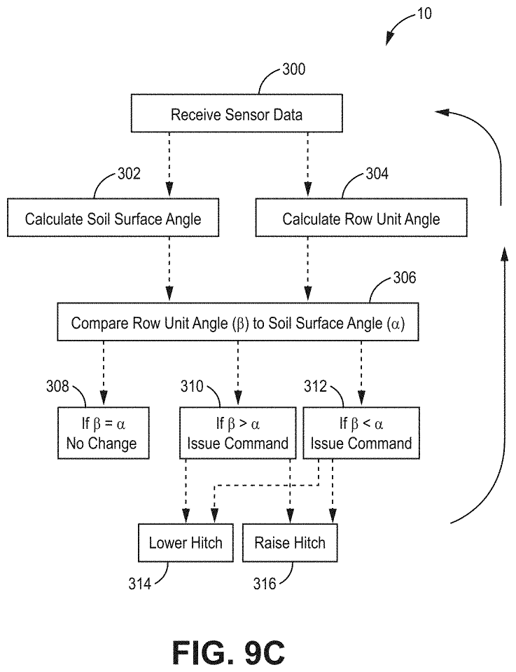

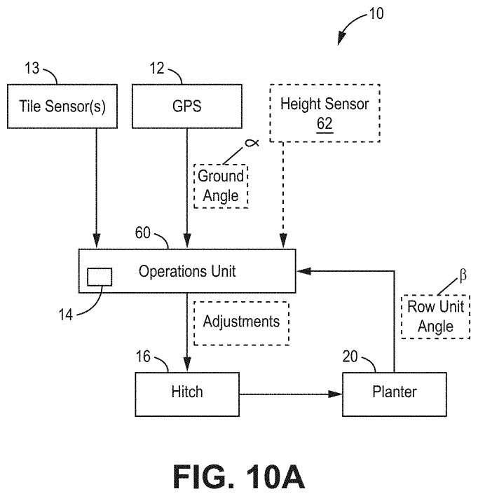

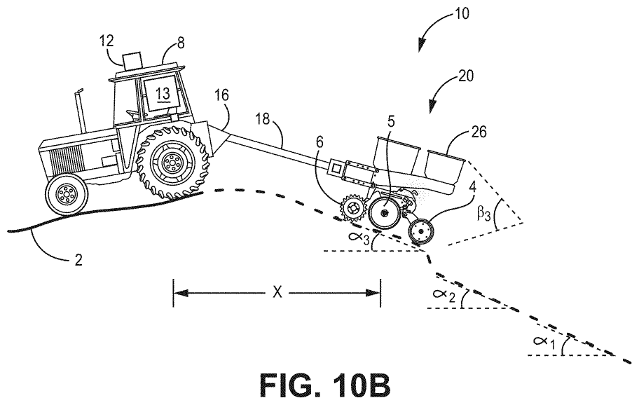

Turning now to FIGS. 9A-10B, the system 10 according to certain implementations utilizes one or more tilt sensors 13 and/or GPS systems 12 disposed on the tractor 8 or other agricultural vehicle 8 to measure the angle/pitch/incline/grade of the soil surface 2. That is, in various implementations, at least one tilt sensor 13 and at least one GPS 12 are positioned on the tractor 8 and/or planter 20, such that in various implementations, a tilt sensor 13 is on both the tractor and planter 20, or alternatively, there is a tilt sensor 13 on the planter 20 and a GPS 12 on the tractor 8, or, in certain implementations a GPS 12 on the tractor 8 along with a tilt sensor 13. In various implementations, the tilt sensor 13 is on the planter 20. In some implementations, the tilt sensor 13 is specifically on the planter toolbar 22. In various further implementations, one or more tilt sensors 13 may be disposed on the planter row units 26.

In each of the various implementations, the system 10 makes calculations as described herein to estimate the topology and relevant pitch angles and signals from the tilt sensor(s) 13 and/or GPS 12, which are used by the system's 10 operations unit 60 to control hitch 16 movement to adjust the pitch between the tractor 8 and planter 20 for optimal performance.

As shown in FIGS. 9A-10C, in various implementations a GPS 12 and/or tilt sensor(s) 13 may be used to transmit position and terrain information to the operations unit 60 for processing and execution of actuator 40, 90 movements, which enables the planter 20 and/or row unit 26 to remain parallel to the soil surface 2. In some implementations, the GPS 12 on the tractor 8 logs characteristics of the soil surface 2 ahead of the planter 20. The operations unit 60 then uses those logs and measurements to determine where on the soil surface 2 the seeding point is located. The operations unit 60 may then determine the soil surface angle α and control the height of the hitch 16, or other actuator 40, 90, to orient the toolbar 22, parallel arms 24, and/or row unit 26 such that the soil surface angle α and row unit angle β are approximately aligned.

As shown in the flowchart at FIG. 9C, various implementations of the system 10 perform a variety of optional steps and sub-steps. In the implementation of FIG. 9C, the system 10 optionally receives sensor data (box 300) such as tilt sensor data, GPS data, row unit height data, stored soil surface data and/or pivot wheel data, for example. Further data sources are of course possible.

In various implementations of the system 10, the system 10/operations unit 60 optionally calculates the soil surface angle (α) (box 302) and/or row unit angle (β)(box 304). In various implementations, a time-series of these angles α, β is recorded. In various implementations, the row unit angle β is estimated, as is described further in the implementation of FIG. 10B, for example. In further implementations, historical data relating to the pitch of the soil surface is used. In certain implementations, one or both of the soil surface angle (α) and/or row unit angle (β) is directly measured, so no calculation is required.

In a further optional step, the soil surface angle (α) is compared row unit angle (β) (box 306). If the angles α, β are equal, no change is made to the hitch height (box 308). If a difference between the angles is measured (boxes 310 and 312), the system 10 via the operations unit 60 and/or controller 14 issues a command to lower (box 314) or raise (box 316) the hitch. It is appreciated that in various implementations, the angles α, β can be measured as positive or negative, and can be recorded either relative to the direction of travel or behind the direction of travel, so either observation (boxes 310 and 312) can cause the issuance of either command: raising (box 316) or lowering (box 314), as would be understood.

It is appreciated that both α and β can be positive or negative pitch values, and that the system 10 is able to correspondingly compare those angles α, β to calculate commands delivered to the hitch 16 to cause corresponding adjustment of the hitch 16 to bring the angles α, β into the desired alignment.

In some implementations, this position and terrain information includes the soil surface angle α. In certain implementations, a tilt/incline sensor 13 disposed on the tractor 8 and/or planter 20 may be used to measure the soil surface angle α by measuring the tilt/angle/incline of the tractor 8 and/or planter 20 with respect to a flat/non-angled surface or gravity, as would be understood.

The operations unit 60 may then calculate or determine a time-series of the soil surface angles α₁, α₂, α₃, etc., at each seeding point or at various locations in a field, as is shown for example in FIG. 10B. It is understood that the seeding point is the location in the soil 2 where a seed is to be deposited during planting. In certain implementations, soil/terrain information can also be obtained from one or more databases 64 or other memory 64 in communication with the operations unit 60/controller 14, as is shown in FIG. 10A.

In various implementations, and as shown in FIGS. 9A-10A, the operations unit 60 also receives inputs regarding a current/real-time toolbar angle β or row unit angle β, as would be appreciated. In certain implementations, the real-time row unit angle β is measured by a tilt sensor 13 on the planter 20, toolbar 22, and/or individual row unit 26. In various alternative implementations, the current row unit angle β is derived from various other data such as the known location of the planter 20, the known soil surface angle α at the location, and/or any adjustments made to the height of the hitch 16 and/or the row unit 26 angle, as described herein.

In another alternative implementation, and as shown in FIG. 9A, an optional height sensor 62 is placed in front of the row units 26 and is rigidly mounted to the toolbar 22. In various implementations, the height sensor 62 is a sonic or LIDAR sensor, although other sensor types are possible and would be appreciated by those of skill in the art. As the soil surface angle α changes, a change in height between the toolbar 22 and the soil surface 2 will be registered and communicated to the operations unit 60 such that the changing soil surface angle α can be calculated in real time or near real-time for adjustment as necessary, as would be appreciated. It is understood that height measurements received from the height sensor in these implementations can be used to adjust the hitch 16 height based on a known desired toolbar height (Y).

As would also be appreciated, a planter 20 (including its row units 26) should be parallel or nearly parallel to the soil surface 2 to ensure proper seeding. That is, the row unit angle β and soil surface angle α should be equivalent or nearly equivalent, such that seeds are being placed to the correct depth during planting operations to maximize yield. Said another way, the bottom of a square toolbar 22 should be parallel or nearly parallel to the soil surface 2. In various implementations, the toolbar 22 and row units 26 are orientated such that the planter shank is perpendicular to the soil surface 2. By orienting the planter toolbar 22 parallel to the soil surface 2 the row units 26 and components thereof, such as but not limited to row cleaners 6, opening discs 3, closing discs 4, seed tubes, firmers, and the like are properly positioned on the soil surface 2 for the best performance, as would be understood.

In use according to the implementation of FIG. 10B, as the tractor 8 covers the soil surface 2 while traversing the field, a time-series of soil surface angle α₁, α₂, α₃ measurements, which may be derived from the GPS 12 and/or tilt sensor 13 installed on the tractor 8. It is appreciated that the system 10 can also be recording latitude, longitude, elevation and the like. As the system 10 logs the time-series of soil surface angle α₁, α₂, α₃ measurements, it also calculates the soil angle or slope on the basis of each soil surface angle α₁, α₂, α₃ point, and optionally the points surrounding it which are stored by the system 10 memory 64, as discussed above. In these implementations, the system 10 is therefore able to utilize the known distance (X) between the tractor GPS 12/tilt sensor 13 and the planting location of the row unit 26, which is a fixed distance behind the tractor 8. With the input of the speed of the tractor 8, the operations unit 60 is thereby able to calculate and compare the relevant angles and adjust the row unit angle β₃ 20 to match the relevant time-series logged soil surface angle α₃, as has been previously described. That is, in these implementations, the system 10 is able to utilize measurements made on the tractor 8 only to adjust hitch height and equalize the angles α₃, β₃.

In a further optional step, the operations unit 60 can use the various inputs to send a signal to the automated hitch 16/actuator 40 to adjust the hitch 16 height up or down so that the row unit angle β and soil surface angle α are equal, near equal, or at any other angle relative to one another for the best performance of the planter 20. In certain implementations, when the row unit angle β and soil surface angle α are equal, the base of the planter toolbar 22, and thus row unit 26, is parallel to the soil surface 2. Alternatively, the operations unit 14 can use the various inputs to send a signal to one or more actuators 90 on the parallel 24 arms of the row units 26 to adjust the angle of the row unit 26 relative to the toolbar 22, as will be discussed further below.

As would be appreciated, seeding quality can be highly dependent on the angle of the planter 20, or row units 26, relative to the soil surface 2. Seeding quality is improved when the planter 20 is parallel or nearly parallel to the soil surface 2, shown for example in FIGS. 9A-10, by ensuring proper contact and positioning between various planter 20 components and soil 2. The system 10 is implemented to ensure that the row unit angle β and soil surface angle α are parallel or nearly throughout planting, regardless of the terrain being traversed.

In another implementation, the system 10 utilizes a tilt sensor 13 on the tractor 8 to determine the incline/slope/angle/tilt of the soil surface 2. When the planter 20 and row units 26 reach the seeding point the hitch 16 may be raised or lowered until the row unit 26 or toolbar 22 slope/angle/tilt 21 matches the incline/slope of the soil surface angle α.

In a further implementation, a second tilt/incline sensor 13 may be placed on the planter toolbar 22 and/or on some or all of the row units 26 for use in a closed loop control system, as will be discussed further below.

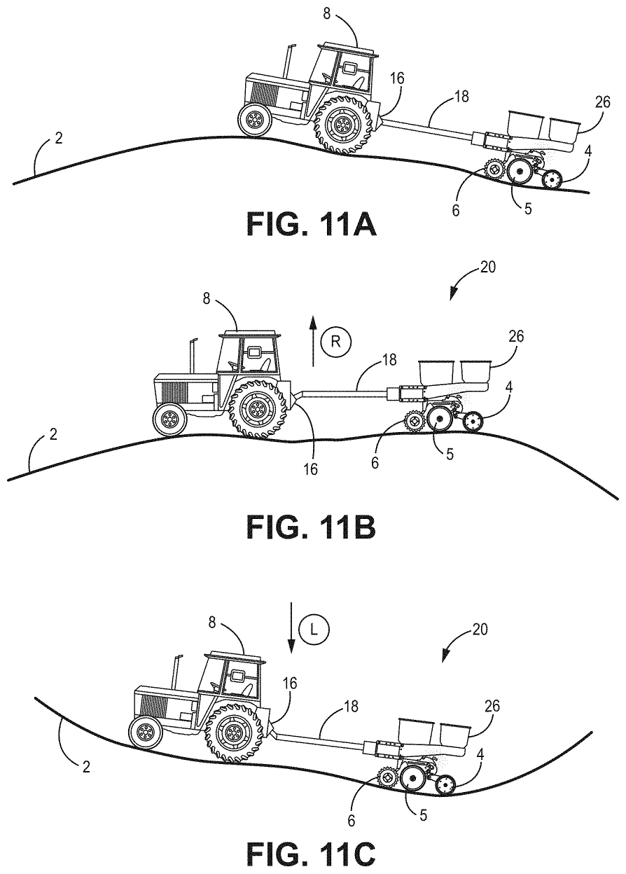

In one specific example, at the beginning of planting the planter 20 is attached to the tractor 8 such that the planter toolbar 22 is parallel to the soil surface 2, shown for example in FIG. 11A. That is, the automated hitch 16 or other components, as discussed herein, are positioned so that the planter 20 is parallel to the soil surface 2. As planting progresses and the tractor 8 traverses various terrain, such as reaching a peak of an incline, the system 10 continuously or periodically measures soil incline and planter angles. In this example, at the peak of an incline, the system 10/operations unit 60/processor 14 will send an output signal or command to the hitch 16 such that the hitch 16 will be increased in height to maintain the planter 20 parallel to the soil surface 2, as shown in FIG. 11B (reference arrow R). In another example, when the tractor 8 reaches a valley the automated hitch 16 will be signaled to decrease in height so the planter 20 remains parallel to the soil surface 2, shown in FIG. 11C (reference arrow L).

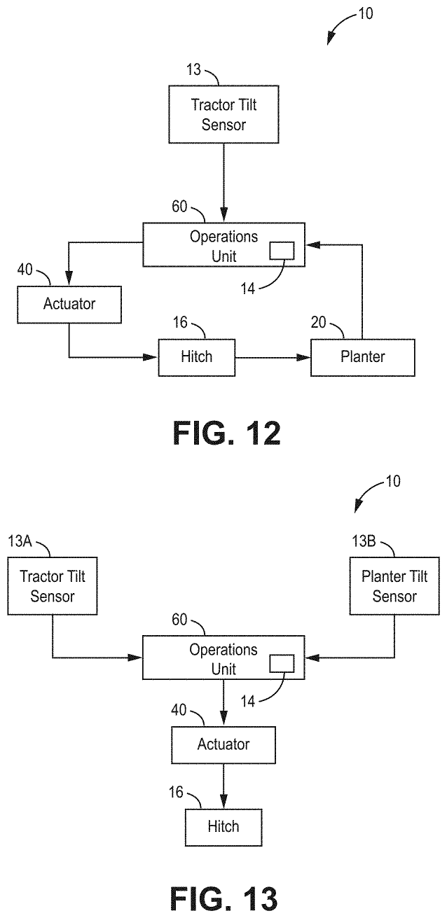

Turning now to FIG. 12, in certain implementations, the tractor 8 has a tractor tilt sensor 13 that determines the soil surface angle α at various locations in the field, such as in a time series. The soil surface angle α from the tractor tilt sensor 13 is utilized by the operations unit 60 to determine if adjustment of the hitch 16 is proper so that row unit angle β is equivalent or nearly equivalent to the soil surface angle α. In various implementations, the operations unit 60, optionally through the controller 14, dynamically adjusts the hitch 16 height so that when the planter 20 reaches the seeding point, the hitch 16 is urged either up or down as appropriate so that the row unit angle β and soil surface angle α are equivalent (or nearly equivalent) and the planter 20 is parallel to the soil surface 2.

In a further alternative implementation of the system 10, shown for example in FIG. 13, the tractor 8 and planter 20 include a tractor tilt sensor 13A and a planter tilt sensor 13B, respectively. In these and other implementations, the tractor tilt sensor 13A and planter tilt sensor 13B create a closed loop feedback system wherein the row unit angle β and soil surface angle α are continuously or periodically being collected and inputted to the operations unit 60, as was previously described. In these implementations, the system 10 compares the angle measured by the tractor tilt sensor 13A for a given location with the angle measured by the planter tilt sensor 13B at the same location. The angles should be equal or nearly equal so that the planter 20 and row units 26 remain parallel or nearly parallel to the soil surface 2. If the row unit angle β would not match the soil surface angle α, the operation unit 60 can send a signal to the actuator 40 such that the automated hitch 16 to be urged either up or down as necessary so that the planter 20 is again parallel to the soil surface 2, as would be appreciated.

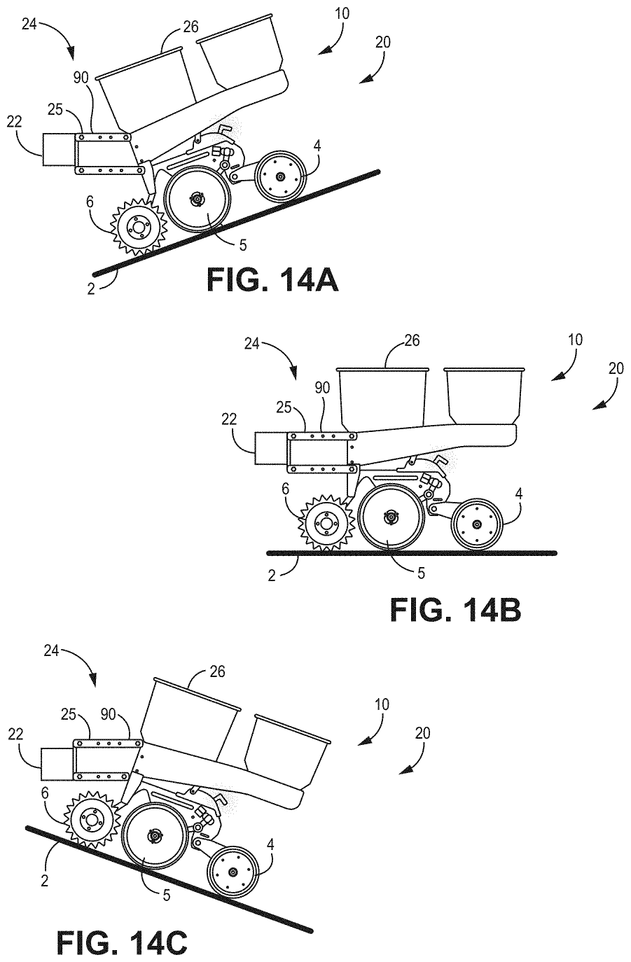

Turning now to FIGS. 14A-C, in an alternative implementation, the system 10 is constructed and arranged to adjust the length of the top parallel arms 24 in order to adjust the angle of the row unit 26 relative to the toolbar 22. In various of these implementations, the hitch 16 height may remain static. In further implementations, adjustment to hitch 16 height, as discussed above, may be done in conjunction with adjustment to the parallel arms 24.

As noted above, in various configurations, individual row units 26 are attached to a planter toolbar 22 via parallel arm linkages 24. In certain implementations, these parallel arm linkages 24 include four arms, two top arms and two bottom arms. In certain implementations, the two arms on the top of the parallel arms 24 are telescoping arms 25. In these implementations, the telescoping arms 25 can be actuated to either increase or decrease in length. In various implementations, the telescoping arms 25 may include a hydraulic, pneumatic, or electric piston.

As shown in FIG. 14A the telescoping arms 25 may be shortened thereby tilting a row unit 26 forward or toward the toolbar 22. In FIG. 14B the telescoping arms 25 are positioned at a length substantially equal to the length of the lower arms 24, such that the row unit 26 is parallel to the toolbar 22. The telescoping arms 25 may also be lengthened in order to tilt the row unit 26 backwards, away from the toolbar 22, as shown in FIG. 14C.

Various of these implementations allow for row-by-row control of the row unit 26 angle with respect to the soil surface 2, providing more precise control on-the-go.

Implementations with telescoping arms 25 may be integrated into the system 10 such that row units 26 can be tilted dynamically to maintain the row unit 26 in a parallel orientation with respect to the soil surface 2. For example, as a tractor 8 traverses a field, a GPS 12 and/or the various tilt sensors 13 as described above, may input soil surface angle α and planter angle β information to the operations unit 60. The operations unit 60, optionally via the controller 14, may then process those inputs and determine if the planter toolbar 22 and/or row units 26 need to be adjusted to be parallel to the soil surface 2.

As shown in FIG. 14A the telescoping arm 25 is shorted to tilt the row unit 26 forward, for example if the row unit 26 is located on a decline. The telescoping arms 25 may be oriented to be substantially at the same length as the lower arms 24 when the row unit 26 is located on flat soil 2, shown in FIG. 14B. Further, in implementations where the row unit 26 is located on an incline, such as shown in FIG. 14C, the telescoping arms 25 may be lengthened to tilt the row unit 26 backwards.

FIGS. 15A and 15B show an exemplary implementation of such a telescoping arm 25. In these implementations, the telescoping arm 25 includes a single action hydraulic cylinder 90, or similar actuator 90 as would be appreciated. Alternate implementations feature double-action cylinders and/or pneumatic actuators. In these and other implementations, the actuator 90 is in communication with a hydraulic valve 92 or other power/driving source, as would be readily appreciated. In certain implementations, an inertial position sensor, potentiometer, linear sensor or IMU as a cylinder position sensor 94 is in communication with the actuator 90 and configured to detect the position of the piston 96 within the barrel 98 for use in the calibration and in improving accuracy, for example, as would be readily appreciated.

In implementations like those of FIGS. 15A-15B, the actuator 90 is in operational communication with the operations unit 60 and configured to adjust the parallel arm angle θ via linear extension or retraction of the actuator (shown at reference arrow C). As would be appreciated, in these implementations the actuator 90 can thereby be used to increase the arm angle θ and create a corresponding adjustment between the row unit 26 and tractor 8, as described above. In various implementations, these arm angle θ adjustments can be done in combination with the adjustments of the hitch 16 to address differences between the soil surface angle α and row unit angle β by the system 10.

As shown in FIG. 15C, accordingly in various implementations of the system 10, the operations unit 60 is configured to receive position data (box 330) or other data, such as from GPS 12, tilt sensors 13, historical data, row unit height data and the like, which for example can be a time-series of data points relating to soil surface angle α and/or row unit angle β for use by implementations like those in FIGS. 15A-15B.

Further, in an optional step, the soil surface angle α and row unit angle β are compared (box 332), such as by the processor 14 and/or operations unit 60. If there is no difference (box 334), no command is issued (box 340), but if there is a difference observed between α and β (boxes 336-338), a command can be issued to the cylinder to extend or retract (box 342) so as to alter the angle between the toolbar and row unit: the arm angle θ, as would be readily appreciated. Further implementations are of course possible, and this configuration of the system 10 can be used with or without adjustments to the hitch described elsewhere herein, or for fine tuning or other calibrations, as would be readily appreciated.

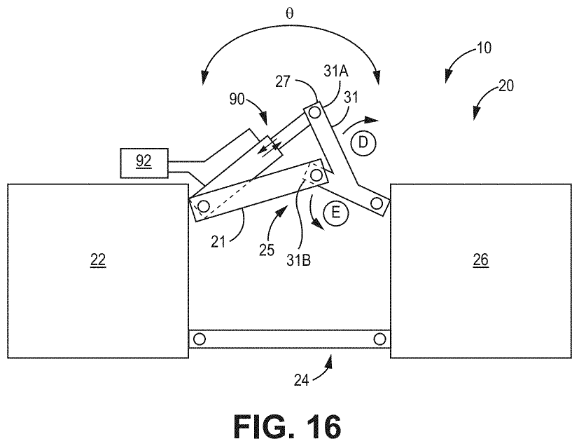

A further implementation of a telescoping arm 25 is shown in FIG. 16. In these and other implementations, the telescoping arm 25 has a pivot mechanism 27 configured for the adjustment of the arm angle θ. In the implementation of FIG. 16, the pivot mechanism 27 has a first arm 21 and actuator 90 that are rotatably attached to a bifurcated second arm 31, which has first 31A and second 31B segments. In these implementations, the first segment 31A is in rotational communication with the actuator 90 and the second segment 31B is in rotational communication with the first arm 21 such that linear actuation of the actuator 90 (extension or retraction) pivots the bifurcated second arm 31 in a first direction (reference arrow D) or second direction (reference arrow E), respectively, thereby correspondingly increasing or decreasing the arm angle θ, as would be understood. Further implementations are of course possible.

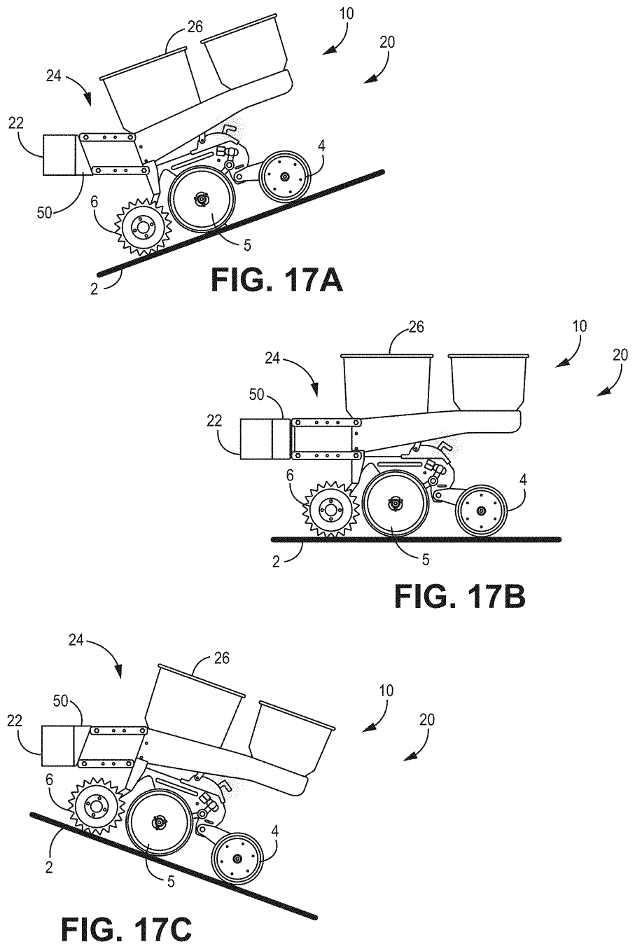

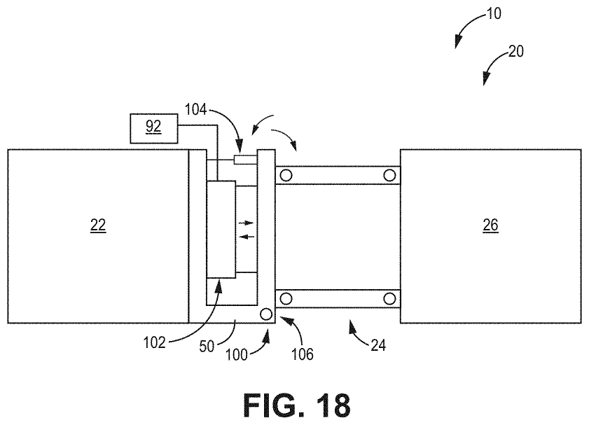

In a further alternative implementation, shown in FIGS. 17A-C, the system 10 may include one or more adjustable plates 50 mounted to the toolbar 22. In various implementations, the plate 50 is connected to the toolbar 22 via at least one actuator 90 and hinge 100 (shown in FIG. 18 and discussed further below) such that the angle of the plate 50 can be adjusted with respect to the toolbar 22. In these implementations, the parallel linkages 24 are connected to the plate 50. In various of these implementations, the parallel linkages 24 are fixed. In certain implementations, the parallel linkages 24 may include telescoping arms 25, as discussed above. Further, in various of these implementations, the hitch 16 may be static or dynamic as discussed above.

In one example, the lower end of the plate 50 may be tilted away from the toolbar 22 in order to adjust the angle of the row unit 26 and tilt the row unit 26 forward, for example on a decline, as discussed above, shown in FIG. 17A. On flat soil, the plate 50 may be oriented to be parallel or otherwise even with the backside of the toolbar 22 such that the row unit 26 is substantially flat, as shown in FIG. 17B. Finally, the plate 50 may be adjusted such that the top of the plate 50 is tilted away from the toolbar 22 pitching the row unit 26 backwards, such as on an incline shown in FIG. 17C.

FIG. 18 shows an exemplary implementation of a hinged plate 50. In various implementations, the hinged plate 50 is controlled with a single action cylinder 102 and valve 92 or other power source, as would be understood. In various implementations a linear potentiometer 104 and encoder 106 are used in conjunction with the hinged plate 50 to determine the position of the plate 50.

In certain implementations, adjustment of the telescoping arm 25 and/or plate 50 located on each row unit 26 may be done in place of adjustment of the hitch 16 height, discussed above. In further implementations, the system 10 may allow for coordinated adjustment of the hitch 16 height, telescoping arm 25 length, and/or plate 50 angle.

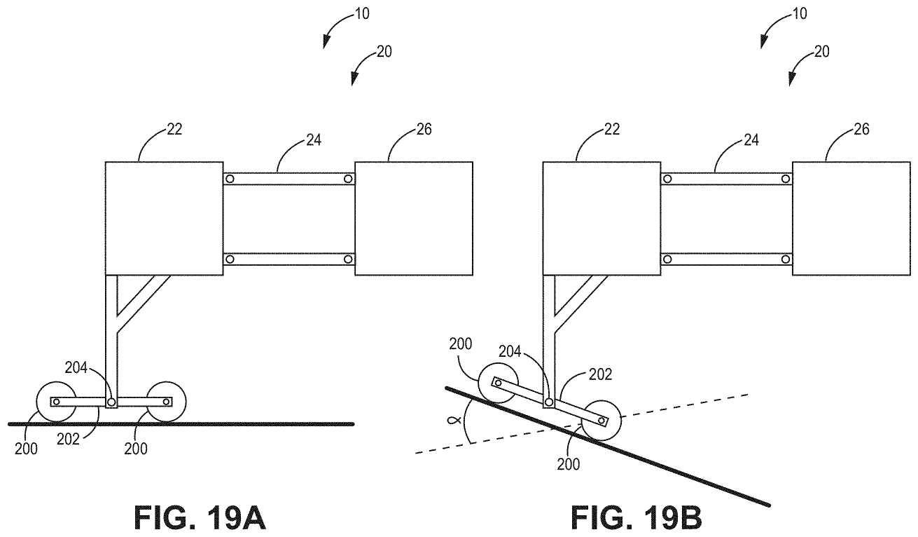

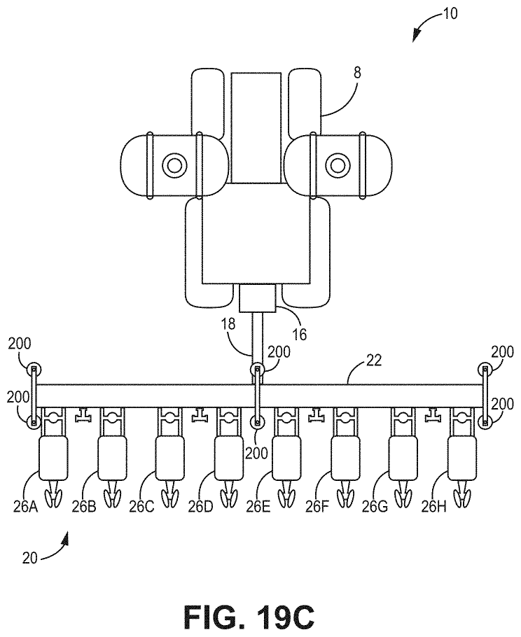

FIGS. 19A-19C depict a further implementation of the system 10, wherein the toolbar 22 is configured such that at certain points along the width of the toolbar 22, tilting wheels 200 are provided and configured to mechanically detect the soil surface angle α across the width of the planter 20. That is, in these implementations, certain of one or more tilting wheels 200 are spaced laterally across the toolbar 22 and have a pivoting bar 202 in operational communication with the pivot wheels 200 and a rotational sensor 204 configured to detect the soil surface angle α at various points across the width of the planter 20. In these implementations, the system 10 is then configured to calculate the average soil surface angle α across the width of the planter for normalization and use against the row unit angle β by the system 10, as would be understood.

As shown in FIG. 19C, the pivot wheels 200 are spaced at intervals along the toolbar 22 of the planter 20, such as for example in the center and at each end, and not necessarily at each individual row unit 26A, 26B, 26C, 26D, 26E, 26F, 26G, 26H, as would be appreciated. It is further appreciated that any number of pivot wheels 200 can be provided, such that they can be distributed at every other row unit, every row unit, every third row unit and the like.

In certain implementations, a filter or normalizing equation or algorithm is executed by the system 10 to average or otherwise account for differences in slope or pitch across the toolbar. For example, if three sets of pivot wheels 200 are provided and two of the three sets have similar readings and the third is an outlier, the system 10 may average the readings or discard the outlier, depending on the configured settings. Many implementations are of course possible.

Although the disclosure has been described with reference to preferred embodiments, persons skilled in the art will recognize that changes may be made in form and detail without departing from the spirit and scope of the disclosed apparatus, systems and methods.

What is claimed is:

1. A system for controlling planter hitch orientation comprising:
(a) a tilt sensor;
(b) an operations unit in communication with the tilt sensor, comprising:
(i) a controller;
(ii) a memory in communication with the controller; and
(iii) a communications component in communication with the controller; and
(c) at least one actuator in communication with the operations unit,
wherein signal from the tilt sensor detect a pitch of a soil surface, and wherein the operations unit sends signals to the at least one actuator to control an angle of a planter to match or nearly match the pitch of the soil surface.

2. The system of claim 1, wherein the at least one actuator is configured to retract and extend a parallel linkage arm connected to a row unit.

3. The system of claim 1, at least one hinged plate connected to the at least one actuator wherein actuation of the actuator causes extension and retraction of the at least one hinged plate.

4. The system of claim 1, further comprising a height sensor configured to be attached to the planter and for measurement of distance between a toolbar and the soil surface.

5. The system of claim 4, wherein the height sensor is one or more of a LiDAR sensor or a sonic sensor.

6. The system of claim 1, wherein actuation of the actuator is on-the-go.

7. The system of claim 1, further comprising a GPS receiver in communication with the operations unit, the GPS receiver configured to log location and soil characteristics.

8. A system for controlling planter pitch comprising:
a. at least one sensor;
b. a controller; and
c. an automated hitch,
wherein the at least one sensor records a soil surface angle, and wherein the controller is configured to adjust the automated hitch to align a row unit angle to be substantially equivalent to the soil surface angle.

9. The system of claim 8, wherein the at least one sensor comprises a GPS, a tilt sensor or a height sensor.

10. The system of claim 9, wherein when the soil surface angle is higher than the row unit angle, the controller causes the automated hitch to be urged upward to increase row unit angle until the soil surface angle and the row unit angle are substantially equivalent.

11. The system of claim 10, wherein when the soil surface angle is lower than the row unit angle, the controller causes the automated hitch to be urged downward to decrease the row unit angle until the soil surface angle and the row unit angle are substantially equivalent.

12. The system of claim 8, wherein the soil surface angle is logged by the system and stored in a memory.

13. The system of claim 8, further comprising a plurality of tilting wheels disposed across a width of the planter and configured to detect the soil surface angle at various points across the width.

14. The system of claim 8, wherein the system is further configured to dynamically adjust the row unit angle of one or more row units of the planter via one or more of a telescoping linkage or hinged plate.

15. A method for controlling planter orientation, comprising:
recording a soil surface angle;
determining a row unit angle; and
actuating an actuator such that the soil surface angle and the row unit angle are parallel or nearly parallel.

16. The method of claim 16, wherein the actuator is configured to raise or lower a hitch.

17. The method of claim 16, wherein the actuator is configured to extend or retract a telescoping arm of a row unit linkage.

18. The method of claim 16, wherein the soil surface angle is detected from one or more stored maps.

19. The method of claim 16, wherein the row unit angle is determined by one or more of a GPS, a tilt sensor or a height sensor.

20. The method of claim 16, wherein actuation of the actuator is on-the-go in real time or near-real time.
